(19) United States
(12) Patent Application Publication
(10) Pub. No.: US 2025/0299277 A1
(43) Pub. Date: Sep. 25, 2025

(54) CONFIRMING CONDITIONAL BEQUEST

(71) Applicants: James D. Cahill, Belmont, MA (US); Yvette M. Hatton, El Cerrito, CA (US); Jack James Malpas-Coker, Dallas, TX (US)

(72) Inventors: James D. Cahill, Belmont, MA (US); Yvette M. Hatton, El Cerrito, CA (US); Jack James Malpas-Coker, Dallas, TX (US)

(21) Appl. No.: 18/610,875

(22) Filed: Mar. 20, 2024

(51) Int. Cl. G06Q 50/18

(52) U.S. Cl. CPC G06Q 50/186

(57) ABSTRACT

Various systems and methods for confirming conditional bequests are described herein. An online system is configured to transmit a confirmation request to a plurality of users of the online system, the confirmation request to provide feedback on a completion of a conditional bequest, the conditional bequest comprising a task to be completed by a beneficiary and a gift to be given to the beneficiary after completion of the task; receive feedback from at least one of the plurality of users; compare the feedback to a confirmation threshold; and record that the conditional bequest was completed when the feedback satisfies the confirmation threshold.

### BACKGROUND

Estate planning covers the transfer of property and assets after death. In complex situations, estate planning includes the guidance and counsel of several advisors. These advisors may include attorneys, accountants, financial planners, life insurance agents, bankers, brokers, and others. The primary document in estate planning is the will, which is a document that provides for the distribution of property at the time of death.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating an operating environment, according to an embodiment;

FIG. 2 is a flow diagram illustrating data and control flow 200 for gamification of bequests, according to an embodiment;

FIG. 3 is an example user interface for creating a conditional bequest of a will, according to an embodiment;

FIG. 4 is a user interface of a task path for a beneficiary, according to an embodiment;

FIG. 5 is a user interface to interact with a node in a task path, according to an embodiment;

FIG. 6 is a user interface to confirm the completion of an task in a conditional bequest according to an embodiment;

FIG. 7 is a flowchart illustrating a method for confirming completion of a conditional bequest, according to an embodiment; and

FIG. 8 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Systems and methods described herein provide a digital estate planning system. Current processes for the creation and management of wills is manually resource intensive and complex, often requiring extensive offline communication between parties and inconvenient storage of paper documents. Furthermore, conventional processes are often isolated and therefore limited in their extendibility into other tangential areas, which may benefit the provision of information associated with a user's estate. As such, a digital will platform provides advantages, such as easier accessibility to users (e.g., testator/will owner and selected designated parties such as beneficiaries, family, friends, financial advisors, lawyers, etc.), more accurate inventory and valuation, and providing an auditable record of transactions.

While some wills may be simple and have a limited number of direct and specific gifts (bequests) enumerated, other wills may be more complex with conditional gifts. The platform described herein supports complex conditional gifts, which may include independent conditional gifts that are granted based on one or more conditions being satisfied, and dependent conditional gifts that include their own conditions and also depend on other gifts and their conditions having been satisfied first. The platform may be viewed as a gamification of bequests with electronic achievement tracking, automatic disbursement of gifts when conditions are satisfied, and auditable logs of gifts for administrators (e.g., estate administrator, executor, trustee, etc.).

Systems and techniques described herein provide a digital will platform for the creation and management of a digital will by a testator along with any designated parties. An easy user-friendly interface is used to update to the digital will in real-time, thereby providing an accurate will with up-to-date information. Authenticated users may interact with the digital will platform to create or modify achievements, track events, confirm completion of events, and disperse assets to beneficiaries. These functions and others are described in more detail below.

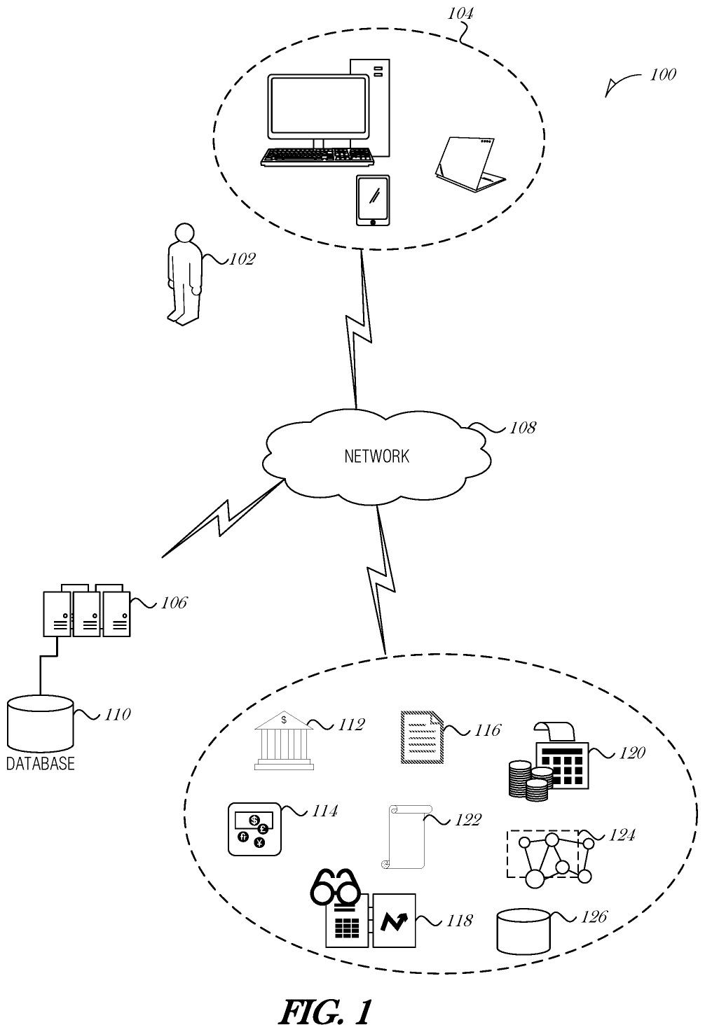

FIG. 1 is a diagram illustrating an operating environment 100, according to an embodiment. A user 102 may use a user device 104 to access an online digital estate planning system 106. The user device 104 may be of any type of form factor including, but not limited to a desktop computer, a mobile device, a laptop computer, a smartphone, a tablet device, a personal digital assistant, or the like.

The online system 106 may include various web servers, database servers, proxy devices, firewalls, storage devices, and network devices. The online system 106 may provide a web-based interface accessible via a uniform resource locator (URL). The online system 106 may provide various levels of security, such as requiring an account with a username and password, a secure channel (e.g., HTTPS), two-factor authentication, and the like.

To connect to the online system 106, the user 102 may execute an application (“app”) to connect via a network 108. In various examples, the servers and components in the operating environment 100 may communicate via one or more networks such as network 108. The network 108 may include one or more of local-area networks (LAN), wide-area networks (WAN), wireless networks (e.g., 802.11 or cellular network), the Public Switched Telephone Network (PSTN) network, ad hoc networks, cellular, personal area networks or peer-to-peer (e.g., Bluetooth®, Wi-Fi Direct), or other combinations or permutations of network protocols and network types. The network 108 may include a single local area network (LAN) or wide-area network (WAN), or combinations of LANs or WANs, such as the Internet.

Data used in online system 106 may be organized and stored in a variety of manners. For convenience, the organized collection of data is described herein as database 110. The specific storage layout and model used in database 110 may take a number of forms-indeed, database 110 may utilize multiple models. Database 110 may be, but is not limited to, a relational database (e.g., SQL), non-relational database (NoSQL) a flat file database, object model, document details model, or a file system hierarchy. The database 108 may store data on one or more storage devices (e.g., a hard disk, random access memory (RAM), etc.). The storage devices may be in standalone arrays, part of one or more servers, and may be located in one or more geographic areas.

A database management system (DBMS) may be used to access the data stored within database 110. The DBMS may offer options to search the database 110 using a query and then return data in the database 110 that meets the criteria in the query. For example, a SQL query may be utilized to retrieve all beneficiaries related to an estate planning document for a specific customer or another query may be used to retrieve all assets associated with a specific beneficiary. Another query may retrieve potential assets or beneficiaries as identified by processes described below. The DBMS may operate on one or more of the components of the online system 106.

The online system 106 provides an electronic estate planning and management platform. One function provided by the online system 106 is to manage assets and beneficiaries of wills. Another function provided by the online system 106 is to manage gifts that are given based on achievements (conditional gifts), track progress and completion of achievements, and distribute the gift after confirming the condition is satisfied. Another function provided by the online system 106 is to allow witnesses to confirm that an achievement was completed.

A will is a legal document that outlines the distribution or transfer of property at the time of death. In many jurisdictions, a will is required to be a written document, signed by the testator, and witnessed by at least two people. The testator is the person who is making the will. The will includes one or more bequests, which are provisions that leave property to a beneficiary. A beneficiary is someone who receives an inheritance (also referred to as a gift or bequest) though a will. Beneficiaries may be a natural person, a charity, a corporation or other legal entity, a trust, a pet, or the like.

In some jurisdictions, a personal property memorandum may be used to leave specific gifts. A will can reference a personal property memorandum and incorporate the gifts listed in the memorandum. The memorandum requires a signature of the decedent, but does not require a witness' signature. Personal property memorandums are used to gift tangible personal property, such as furniture, art, jewelry, and the like. However, personal property memorandums are not used for real estate or intangible personal property, such as money, stocks, bonds, or intellectual property. The systems and techniques described herein may be used to prepare and manage beneficiaries and assets for use in a personal property memorandum or similar document.

In addition to wills, which are executed after a person dies, the systems and techniques described herein may be used to manage beneficiaries and assets for gifts that are performed during the donor's life. A trust may be formed where the donor is the trustee and conditional gifts are based on objective achievements that one or more beneficiaries may complete to earn the gift. Assets that are distributed while the donor is alive may reduce the size of the estate and may be tracked by the systems described herein. As such, the systems and techniques are useful to a person for asset management before and after death.

In operation, a user 102 may log into the online system 106 to access their account. The user 102 is able to create, modify, or delete elements of a will. The elements include assets, beneficiaries, and bequests. Assets include any property that is at least partially owned by the testator of the will. The user 102 may be the testator or another person who is authorized to make changes to the testator's will (e.g., a person with power of attorney). The testator or another party may assign people who are authorized to change the elements of the will in the online system 106, such as a trustee, parent, executor, one with power of attorney, etc.

It is not uncommon to have to change beneficiaries of a will. Beneficiaries may change because of a marital status change (marriage or divorce), a birth, a new possible beneficiary or death of a named beneficiary, a legal name change, or other events. The user 102 is able to add or modify beneficiaries of bequests.

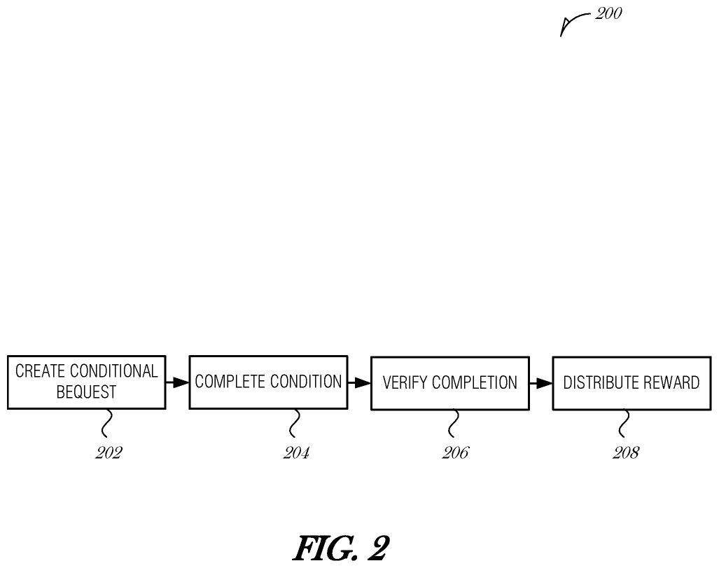

The primary use of the online system 106 is to manage bequests. In the system described here, the user 102 may implement one or more conditions on a bequest. Conditional bequests are a combination of a beneficiary (or beneficiaries), one or more conditions, and a gift (e.g., reward, bequest, points, etc.). Construction of conditional bequests are described in more detail in FIG. 2 below. Other users 102 of the online system 106 may be beneficiaries and use the system to access available conditional bequests, update their progress toward a condition (achievement), provide documentation to prove a status of the condition, and obtain the gift (e.g., reward, funds, points, securities, etc.). The online system 106 may be implemented in a distributed manner, such as by using Web 3.0 design principles or by using DAO (Decentralized Autonomous Organization) systems. The use of an immutable ledger (e.g., a blockchain) may be useful to add long-term recordation, an ability to audit data and transactions, and other security, integrity, and attestation features.

The online system 106 is connected to one or more other systems, which may include banking system 112, brokerage system 114, insurance system 116, credit bureau system 118, tax and revenue system 120, title and licensing system 122, social media system 124, and other sources 126. While some systems are illustrated in FIG. 1, it is understood that the online system 106 may be connected to any of a variety of online systems to coordinate property transfers, document achievements, or the like.

The banking system 112 may include various types of systems that support or provide financial services such as loans, savings accounts, checking accounts, debit accounts, and the like. The banking system 112 may be used to disburse funds to a beneficiary.

The brokerage system 114 may include various types of systems that support or provide financial services such as buying or selling stocks, mutual funds, bonds, options, and other securities. The brokerage system 114 may be used to distribute securities (e.g., stocks, bonds, mutual funds, etc.) or liquidate securities and disburse the liquidated funds to a beneficiary.

The insurance system 116 may include various types of systems that support or provide services such as auto insurance, life insurance, property insurance, annuities, and the like. Funds may be obtained from a life insurance policy, for example, and funds may be distributed from the insurance system 116 or via the banking system 112 or brokerage system 114.

The credit bureau system 118 may include various types of systems that support or provide financial services such as credit application processing, creditworthiness ratings, debt collection tracking, borrowing and bill-paying habits, and the like. The credit bureau system 118 may be used to check on a beneficiary's credit rating, check for opening or closing accounts, or perform other credit worthiness checks. For instance, a conditional bequest may be for a beneficiary to obtain a certain credit rating before completing an achievement and earning a bequest.

The tax and revenue system 120 may include various types of systems that support or provide services such as personal or business tax collections and refunds, and track revenues collected from taxes on income and profits, social security contributions, taxes levied on goods and services, and the like. The tax and revenue system 120 may be a regional system, such as a local, state, or federal system. The tax and revenue system 120 may be used to obtain tax records of a beneficiary to check or verify an income, charitable contributions, or other aspects of a taxpayer.

The title and licensing system 122 may include various types of systems that support or provide services to track ownership of personal or business property such as automobile licensing, driver's licenses, business permits and licenses, residential home titles, and the like. The online system 106 may interface with a title and licensing system 122 to transfer title to a property, check whether a beneficiary has obtained title to a particular property or a type of property (e.g., the beneficiary purchased a house), or perform other actions.

The social media system 124 may include various types of systems that support or provide services to share photos, blog posts, meetings, stories, and the like, to the general public, a subscribed group, friends and family, or other audiences. The social media system 124 may be used to verify achievements or obtain proof for other aspects of a beneficiary, such as to check whether a beneficiary has travelled to a particular destination, moved to a particular location, changed marital status, has adopted a child, etc.

Other sources 126 may include newspapers, online search engines, online news outlets, and the like. For instance, a newspaper may publish birth or death announcements, work promotions, or other information about achievements.

By interfacing with one or more of these systems 112-126, the online system 106 is able to gather a broad spectrum of information about the user 102 and the beneficiaries including past purchases or sales, intended or planned future purchases or sales, income and debt levels, occupation and social circles, family demographics, spending and saving trends, travel and interests, political and religious affiliations, and more. Using this information, the online system 106 is able to track the progress of achievements or tasks. After identifying these status changes, the online system 106 may notify the user 102, update one or more conditional bequests of a will, remove one or more conditional bequests, distribute funds, accrue points, or perform other operations as discussed herein.

The online system 106 may also be used to manage estate assets and beneficiaries of a will. Adding an asset to a will, may include operations such as 1) identifying and naming the potential asset, 2) notifying a testator of the potential asset to confirm that the asset should be added to the will, and 3) adding the asset to a list of assets associated with the will. The notification may be performed using an electronic notification (e.g., email, text message, pop up user interface element, etc.). The confirmation may also be performed using electronic means, such as with a user interface interaction. The electronic means for notification and confirmation may be via an electronic estate management platform, such as online system 106 from FIG. 1. Notification and confirmation may also be performed via post mail, physical documents, or other mechanisms.

Additionally, adding an asset to a will may include the computational operations of adding an asset record to a database and associating the record with one or more other records to indicate the relationship between the asset record and the one or more other records, where the other records may be records for people (e.g., beneficiaries), assets (e.g., for a pool of assets), valuation (e.g., to determine or track valuation of the asset), ownership (e.g., to identify a share of ownership that the testator has in the asset), or other data regarding the asset. An asset record may include an asset identifier (ID), an asset name, an asset description, an asset type, an asset valuation, an asset pool identifier (foreign ID for an asset pool), a beneficiary identifier (foreign ID for a beneficiary or beneficiary pool), and other information about the asset.

Alternatively, removing an asset from a will, may include operations such as 1) receiving an asset identifier, 2) notifying a testator of the asset to confirm that the asset should be removed from the will, and 3) removing the asset from a list of assets associated with the will, along with removing any relationships between the asset and beneficiaries or other assets. As with the process for adding an asset, the notification may be performed using an electronic notification (e.g., email, text message, pop up user interface element, etc.). The confirmation may also be performed using electronic means, such as with a user interface interaction. The electronic means for notification and confirmation may be via an electronic estate management platform, such as online system 106 from FIG. 1. Notification and confirmation may also be performed via post mail, physical documents, or other mechanisms.

Additionally, removing an asset from a will may include the computational operations of removing or deactivating an asset record from a database and removing association of the record with one or more other records. To deactivate the asset, the attribute may be changed from a logical TRUE to a logical FALSE. Maintaining the asset record after disposal or sale of the real world property may be useful, such as in a case where the asset may be re-purchased or recovered (e.g., after recovery from theft or loss). Assets may also be deactivated after they are distributed, such as when a donor gives away an asset before death. Such transactions are captured and maintained for others' reference, for instance to determine which donees were granted which gifts.

The testator may also add a beneficiary to a will, which may include operations such as 1) identifying and naming the potential beneficiary, 2) notifying a testator of the potential beneficiary to confirm that the beneficiary should be added to the will, and 3) adding the beneficiary to a list of beneficiaries associated with the will. The notification may be performed using an electronic notification (e.g., email, text message, pop up user interface element, etc.). The confirmation may also be performed using electronic means, such as with a user interface interaction. The electronic means for notification and confirmation may be via an electronic estate management platform, such as online system 106 from FIG. 1. Notification and confirmation may also be performed via post mail, physical documents, or other mechanisms.

Additionally, adding a beneficiary to a will may include the computational operations of adding a beneficiary record to a database and associating the record with one or more other records to indicate the relationship between the beneficiary record and the one or more other records, where the other records may be records for people (e.g., beneficiaries), assets (e.g., for a pool of assets), or personal information (e.g., home address, phone number, email address, etc.). A beneficiary record may include a beneficiary identifier (ID), a beneficiary name, a beneficiary description, a beneficiary type, and other information about the beneficiary.

Alternatively, removing a beneficiary from a will, may include operations such as 1) receiving a beneficiary identifier, 2) notifying a testator of the beneficiary to confirm that the beneficiary should be removed from the will, and 3) removing the beneficiary from a list of beneficiaries associated with the will, along with removing any relationships between the beneficiary and assets or other beneficiaries. As with the process for adding a beneficiary 210, the notification may be performed using an electronic notification (e.g., email, text message, pop up user interface element, etc.). The confirmation may also be performed using electronic means, such as with a user interface interaction. The electronic means for notification and confirmation may be via an electronic estate management platform, such as online system 106 from FIG. 1. Notification and confirmation may also be performed via post mail, physical documents, or other mechanisms.

FIG. 2 is a flow diagram illustrating data and control flow 200 for gamification of bequests, according to an embodiment. As should be understood, a bequest (also referred to as a gift or an inheritance) is a promise to give or leave something to someone (the beneficiary) by a testator (the one who authored the will or is directing the trust).

At stage 202, a conditional bequest is created or modified using a digital estate planning system. The conditional bequest is composed of multiple properties including a condition to satisfy to obtain the bequest, an identification of the bequest, an identification of a beneficiary. The condition to satisfy may be of several types. For instance, the condition may be to complete a previous condition attached to a different bequest, so that the conditions are linked in a dependency chain. Multiple conditional bequests may be used to create a path of bequests for a beneficiary to traverse. Using this mechanism, the beneficiary may benefit from a larger bequest in stages where smaller bequests are provided. Examples of conditions include, but are not limited to actions to be taken (e.g., have a child, graduate from college, move to Colorado, etc.) or actions to be suppressed (e.g., do not drink alcohol for two years).

The bequest is often money but may be anything from services, real property, intellectual property, securities, licenses, to material assets. The identification of the bequest may be a text description of the bequest (e.g., “$100 cash”), an image or video of the bequest, a serial number or other unique identification of the bequest, or combinations of these types.

The beneficiary may be one or more people who will benefit from the bequest. In some cases, the beneficiary may be a non-person, such as a pet, a business, or a charitable entity like a church or a school. In some examples, the beneficiary may be presented the conditional bequest and may have to actively accept the conditional bequest. The beneficiary may propose a counteroffer to the conditional bequest, such as to modify the action to be taken or suppressed, or to modify the subject matter, type, size, or amount of the bequest. The testator may then negotiate the terms of the conditional bequest until both parties are in agreement and the final terms of the conditional bequest may become part of a will or a directive in a trust. The negotiated conditional bequest may be added as a codicil in a will.

A notification of the creation or modification of the conditional bequest may be transmitted to the beneficiary. The notification may also be transferred to others related to the testator or the beneficiary, such as an executor, a person with power of attorney, a parent of the testator, an attorney of the testator, an accountant of the testator, or the like. The digital estate planning system may store email addresses, cellular phone numbers, or other information to provide the notifications electronically to the beneficiary and others. The beneficiary may have to register with the digital estate planning system in order to create an account and provide contact details to the digital estate planning system. The notification may be performed using an electronic notification (e.g., email, text message, pop up user interface element, etc.). The confirmation may also be performed using electronic means, such as with a user interface interaction. The electronic means for notification and confirmation may be via an electronic estate management platform, such as online system 106 from FIG. 1. Notification and confirmation may also be performed via post mail, physical documents, or other mechanisms.

At stage 204, the beneficiary completes the condition. If the condition was negotiated, then the beneficiary would be required to complete the negotiated condition. The beneficiary may inform the digital estate planning system via an app that is executed on an electronic device of the beneficiary. The electronic device may be a mobile phone, laptop computer, desktop computer, or the like. For instance, the beneficiary may use an app installed on their cellular phone to indicate to the digital estate planning system that an action was performed as part of the conditional bequest.

At stage 206, the completion of the condition is verified. Verification may be performed in different manners depending on the type of action being performed or suppressed in the condition. Verification may be performed automatically or with user feedback. For automatic verification, after the digital estate planning system receives an indication that the beneficiary completed an action or otherwise performed a task to satisfy a condition, the system may interface with one or more external systems to verify that the condition is satisfied. For instance, if the condition was that the beneficiary was to get married, then the system may interface with a courthouse system or a marriage license system to obtain a marriage license or related proof.

At stage 208, a reward is provided to the beneficiary. In some examples, the reward may be an point, marker, credit, or other non-monetary indication of progress. For example, for each conditional bequest completed, the beneficiary may earn 1000 points. The points are aggregated in a “point bucket” that is associated with the beneficiary's digital estate planning system account. The points may be assigned some conversion value to real currency, property, or other assets in the testator's estate. For instance, a conversion may be established that every 100,000 points can be cashed in for $10,000. The money can then be automatically transferred to the beneficiary's bank account, which is linked in the digital estate planning system account to the beneficiary.

In other examples, the reward is a real-world asset, such as a specific amount of money, a piece of personal property, some interest in real property, or the like. The asset may be transferred to the beneficiary's possession. In the case of money, the transfer may be a direct deposit to a financial account of the beneficiary. In the case of other types of property, the transfer may be initiated with electronic instructions from the digital estate planning system to a banker, accountant, executor, realtor, or the like, to complete the transfer to the beneficiary. The electronic instructions may be sent to systems, such as a banking system 112, brokerage system 114, insurance system 116, credit bureau system 118, tax and revenue system 120, or title and licensing system 122 discussed in FIG. 1, to initiate or perform the transfer of assets from the testator to the beneficiary.

The stages 202-208 may be integrated into a game-like environment where the beneficiary is provided challenges, lessons, character interactions, point accumulation, daily quizzes, or other interactions with the digital estate planning system to achieve one or more goals set by the testator. Upon successful conclusion of a game stage, the game player (i.e., the beneficiary) is provided game updates that save progress toward one or more rewards.

This digital experience (e.g., via app and web) turns the inheritance conversation into an objective-driven game. Givers are able to create a path with options and rules around how the inheritance is earned, while beneficiaries can make choices around how they want to earn their rewards, for example, by choosing from a list of actions and relevant rewards.

The gaming environment may take different forms such as an adventure travel game, a murder mystery game, a puzzle game, or the like. Completing sub-goals or larger goals may unlock clues, experience points, in-game items, or other game elements that progress the beneficiary/player through the game experience. There may be in-game interactions with other players (e.g., other beneficiaries or the testator) or non-player characters (NPCs), which are game bots that exist within the gaming environment only. Various gaming scenarios may come pre-packaged and available through the digital estate planning system. Alternatively, the digital estate planning system may provide a build platform for the testator or another person to design and build a game experience that is customized to their liking.

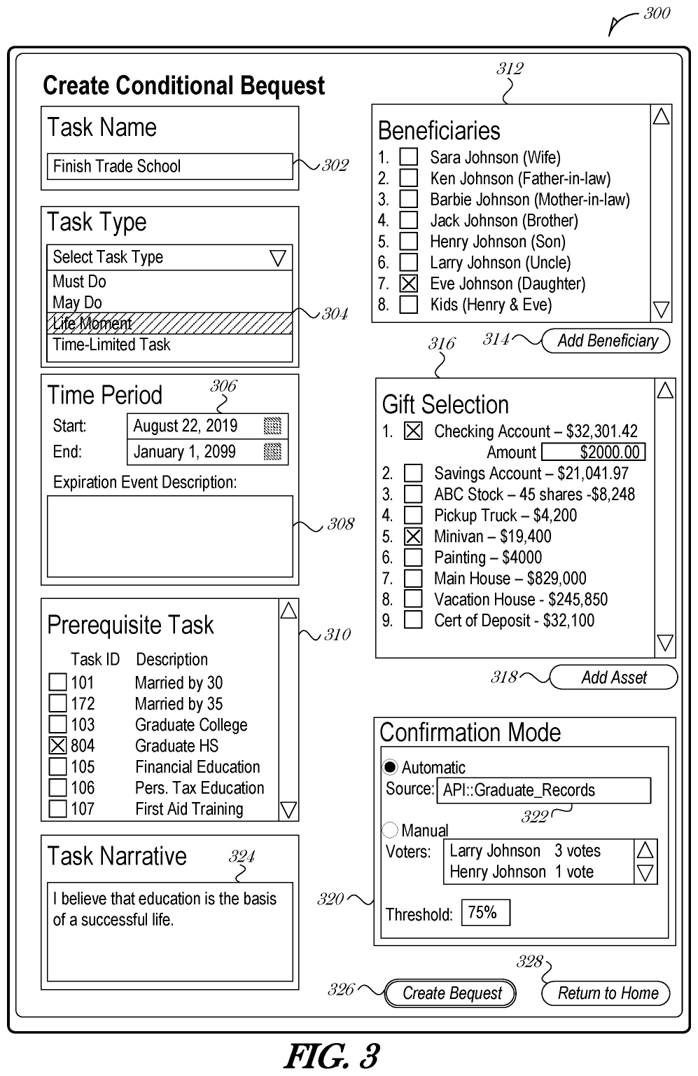

FIG. 3 is an example user interface 300 for creating a conditional bequest of a will, according to an embodiment. The user interface 300 is designed to allow a user to manage elements of a conditional bequest. The conditional bequest may involve having the beneficiary complete one or more tasks in order to earn the bequest. The user may first provide a description or name of the task in the task name user control 302. A task selection user control 304 is used to select the type of task. The tasks may be split into four categories: must-do, may-do, life moments, and time-limited. A must-do task is one that the testator gives high priority and feels that it is important for the beneficiary to complete. For instance, a testator may highly value education and create a must-do task for a beneficiary, where the beneficiary must graduate from college and if so, the beneficiary is gifted a large amount of money if completed.

A may-do task is one that the beneficiary may choose from based on their own appetite for challenges and an evaluation of anticipated effort versus possible reward. The may-do tasks are of lower priority for a testator and the testator may not care as much whether a beneficiary completes these types of tasks. Thus, the potential beneficiaries may select some or all of the may-do tasks.

A life moments task is a one-off life event that unlocks or results in a one-time reward. Life moment tasks may be similar to must-do tasks and it depends on how the testator values the task, whether they consider the task to be a required or view it as a valuable or momentous occasion. Marriage is a good example of a task that may be categorized as either a must-do task or a life moment task. Where some families may consider marriage a complete duty for their children, other families may consider marriage a choice to be made by their children.

A time-limited task is one that is only available for a certain period. Time-limited tasks may be unanticipated and surprising, to incentivize beneficiaries to interact with the platform. The time-limited task may provide various rewards that may be unique or unusual. The gift received from a time-limited task may be a mystery or unknown gift. The beneficiary may be provided a general class or type of object of the gift to give the beneficiary more incentive to complete the conditional bequest. Time-limited tasks may be advertised to a single beneficiary or a pool of beneficiaries. For example, a time-limited task may be advertised to several beneficiaries (e.g., all of the testator's grandchildren) on apps executing on their respective mobile devices, where the time-limited task is to exercise for one hour in one of the next three days to be eligible to have a share of a mystery bank. Grandchildren that exercise (and verify the exercise) will split the money in the mystery bank. The mystery bank may be some amount of money, which could be a large amount and may add to the excitement of interacting with the system.

Any of the tasks may have an expiration associated with it. The expiration may be a specific date or time. Using the time period user controls 306 in the user interface 300, the user may set an activation date or an expiration date for the task. Alternatively, the expiration may be a state or status of a person or event. In this case, an expiration event field 308 may be used to indicate when the task expires. Example tasks include, but are not limited to: 1) beneficiary graduate college by age 25; 2) beneficiary to call estranged brother within one year of testator's death; 3) beneficiary to be sober for a full calendar year; or 4) task becomes active after Jun. 20, 2024 and is available until the beneficiary has their first child.

Task interdependencies may exist. For example, one task may be required to be completed before other tasks unlock and are available to the beneficiary. The user may set a prerequisite task using the task dependency user control 310. In an example, any task that has been created may be selectable in the task dependency user control 310. There may be internal checks to ensure that there are no circular dependencies.

An example of a prerequisite task may be that a task to graduate high school may be required to be satisfied before a task to graduate from college can be available (e.g., unlocked). One or more prerequisite tasks may be used to unlock one or more dependent tasks. A task tree of multiple levels of dependencies may be developed for one or more beneficiaries. A task dependency and the number of people participating in a task are independent properties. For instance, a task that requires a group effort of three siblings may be a prerequired task to three dependent tasks with one task for each of the three siblings. In this way, an estate may be first distributed to a group of beneficiaries and then each member of the group may individually decide whether to perform additional tasks for additional gifts.

A beneficiary selection user control 312 is used to select the beneficiaries that may be assigned the task for the conditional bequest. The beneficiaries may be grouped into beneficiary pools, which are shown as groups in the beneficiary selection user control 312. The list of beneficiaries may be a list of recently used beneficiaries, a list of most commonly used beneficiaries, a list of all beneficiaries that have been assigned to at least one conditional bequest, a list of favorite beneficiaries, or other lists. The user may be able to add a new beneficiary from a list of registered users with the add beneficiary user control 314.

A gift selection user control 316 is used to specify the amount of money or description of the gift to be rewarded to the beneficiaries on completion of the task. The gift selection user control 316 may be a dropdown or selection dialog box that allows the user to select one or more estate assets as the gifts. Items may include tangible or intangible assets of an estate. The user may first select a source of the gift (e.g., a checking account), and then indicate an amount, quantity, or portion of the source is to be used in the gift. The fair market value (FMV) or current account balance may be displayed in the gift selection user control 316 to assist the testator when assigning a value to the gift. An add asset user control 318 may be used to import additional assets to the gift selection user control 316. In the example illustrated in FIG. 3, the user has selected a $2,000 amount from the checking account source and the entire interest in the minivan as the reward for completing the conditional bequest.

A confirmation mode selection user control 320 is used to specify how the completion of a task is to be confirmed. Here, the options include an automatic confirmation or a manual confirmation. For an automatic confirmation, the confirmation mode selection user control 320 provides a text input 322 for the user to describe the network source, application programmer interface (API), microservice, or other facility to access to automatically confirm the completion of a task. For a manual confirmation, the confirmation mode selection user control 320 allows for the user to select one or more people to report confirmations, how much weight each person's feedback is worth, and a confirmation confidence threshold for the amount of feedback required to effectively confirm the completion of the task. People who provide confirmation feedback may not be beneficiaries. As such, the list of people available to select in the confirmation mode selection user control 320 include any user that is registered with the platform and is related to the testator's account. People who are able to provide confirmatory feedback may include, for example, an executor, an attorney, a person with power-of-attorney, a friend, a beneficiary, a trustee, a financial advisor, an accountant, or the like.

A task narrative user control 324 may be used to provide a narration of the task. The description may appear when a potential beneficiary is browsing tasks and considering which tasks to complete, for example. The narration may be used to weave the task into a gaming theme. Alternatively, the narration may be used to provide a basis of why the task is important to the testator. In various embodiments, the narration may be presented as general information for a task, the narration may be provided after a task is completed (e.g., in a completion confirmation popup window), as a reminder text to a beneficiary that is in process of executing the task, or the like.

Once the user is satisfied with the configuration of the conditional bequest, the user may create the conditional bequest using the “create bequest” user control 326. Upon creation of the bequest, the beneficiaries and others (e.g., the user's attorney, accountant, etc.) may be notified. If the user wants to abort the creation of the bequest, then the user may just use the “return to home” user control 328.

In an example use case, grandparents may leave money to a teenager conditional on the teenager reaching some verified level of financial literacy. Through a gaming environment provided by the digital estate planning system, a grandchild can accept challenges, talk with an NPC financial advisor, and collect “points” towards the goal of achieving different levels of financial literacy. The game can be a multiplayer game. For instance, multiple grandchildren may be able to work together toward the same goal of financial literacy. Once the required points are achieved, the conditional gift can be released the grandchild(ren). Tests or quizzes presented in the gaming environment, or other online evaluations may be performed to ensure that the level of literacy is achieved. Because the challenge is entirely within the gaming environment, the interactions with the NPC financial advisor, tests, or quizzes can be detected and logged to provide confirmation of completing the challenge.

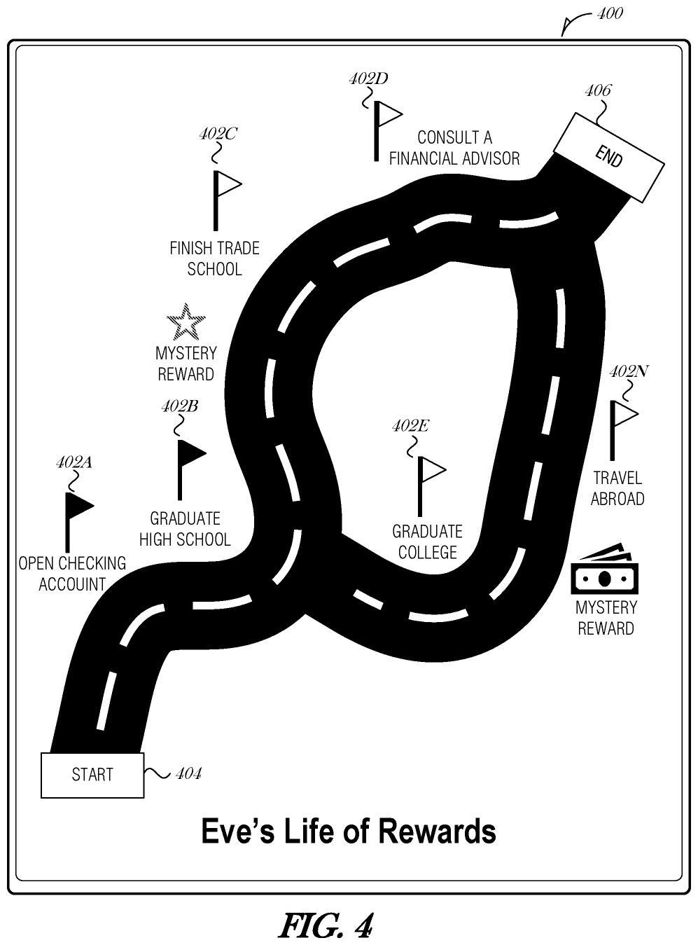

FIG. 4 is a user interface of a task path 400 for a beneficiary, according to an embodiment. The task path 400 includes a number of tasks 402A-N. Each task 402A-N may be associated with one or more conditional bequests, which may be unique to a beneficiary.

Based on a theme of a game, the task path 400 may be incorporated into one or more storylines, plots, or organizations. A narrative may be followed for the various stages of the game while traversing the task path 400. For instance, a computer actor may be used to narrate various tasks, plots, stages, or provide explanations for various elements.

In the example illustrated in FIG. 4, the task path 400 is arranged like a board game, with multiple paths that the beneficiary may follow beginning from a start block 404 and travelling toward an end block 406. It is understood that the gamification of the bequests may take any form including a board game, a card game, a role-playing adventure game, a first person shooting game, a television game show theme, or the like. Gaming elements, such as bonus pools, jackpots, mystery boxes, random prizes, and other elements of chance may be used to enhance the experience.

A testator or other administrator may design and arrange the game elements in the task path 400 according to their desires. The task path 400 may be provided in a bare form with a structure for adding gaming elements. The testator may then add one or more tasks 402A-N to the task path 400, with each task 402A-N from a group of tasks that the testator had created. The tasks 402A-N may be arranged logically in an order that makes prerequisite tasks in their proper place to be completed before dependent tasks. Additional gaming elements, such as a surprise bonus event, may be programmed by the testator with a user interface similar to that illustrated in FIG. 3, where the testator may assign a value (e.g., points, random amount of money, or the like) for the gaming element, a trigger event for the gaming event (e.g., completing the previous task 402A-N in the task path 400), and a narrative for the gaming element (e.g., “Surprise! You've been awarded $4,000!”.

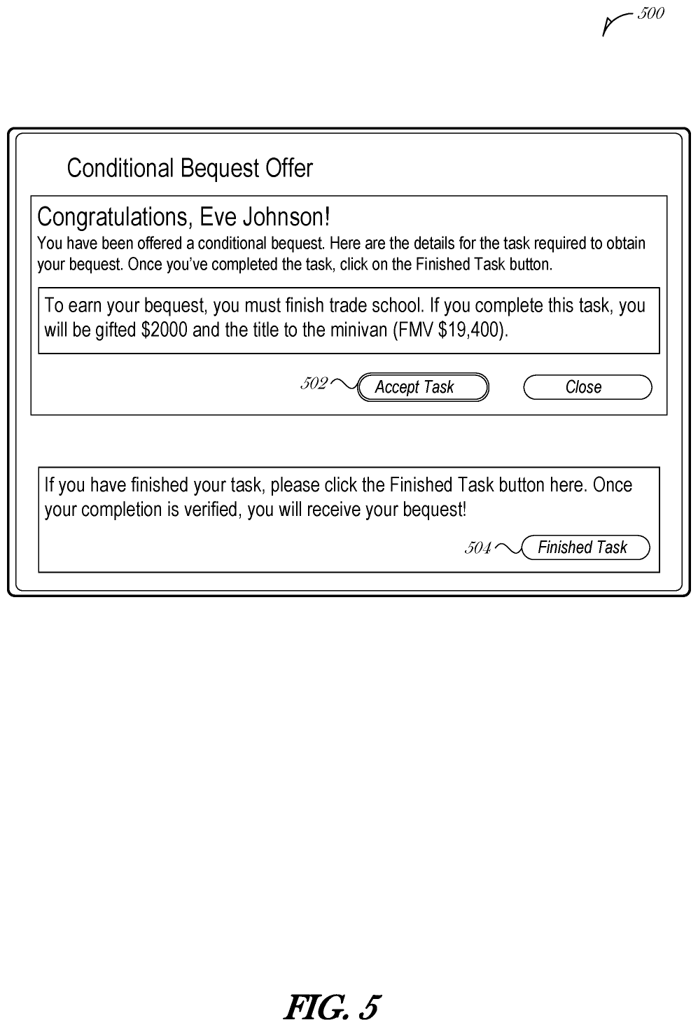

FIG. 5 is a user interface 500 to interact with a node in a task path, according to an embodiment. The user interface 500 may be presented, for example, after a user activates (e.g., clicks, click and hold, double clicks, etc.) on a node in a task path. The user may activate an “accept task” user control 502 to accept the task (if it is an optional task). An electronic message may be transmitted to the digital estate planning system with an indication that the user has accepted the task. The message may include a user identifier, a task identifier, a date and time stamp, and other information to track the acceptance of the task. The message may be sent using a RESTful interface, HTML, or another messaging format. Once the user has accepted a task, the user interface 500 may hide or disable the controls to accept the task again. In its place, a status message may appear, for example “This task was accepted by Eve Johnson on Saturday, Dec. 14, 2002.”

After performing the actions described in the task, the user may activate the “finished task” user control 504. The finished task user control 504 may be disabled or hidden until the user accepts the task. Upon activation, another electronic message may be transmitted indicating that the user is finished with the task. The message may include a user identifier, a task identifier, a date and time stamp, and other information to track the completion of the task. The message may be sent using a RESTful interface, HTML, or another messaging format.

In some cases, confirmation that the task was fully completed is needed before the beneficiary receives their reward. In such cases, the user interface 500 may show a status description indicating the status of the confirmation process. Notification of status changes may be communicated to the user in various ways including a text message, a notification on a locked screen of a mobile device, an icon change in a mobile device's user interface, an email, an audio notification, or the like.

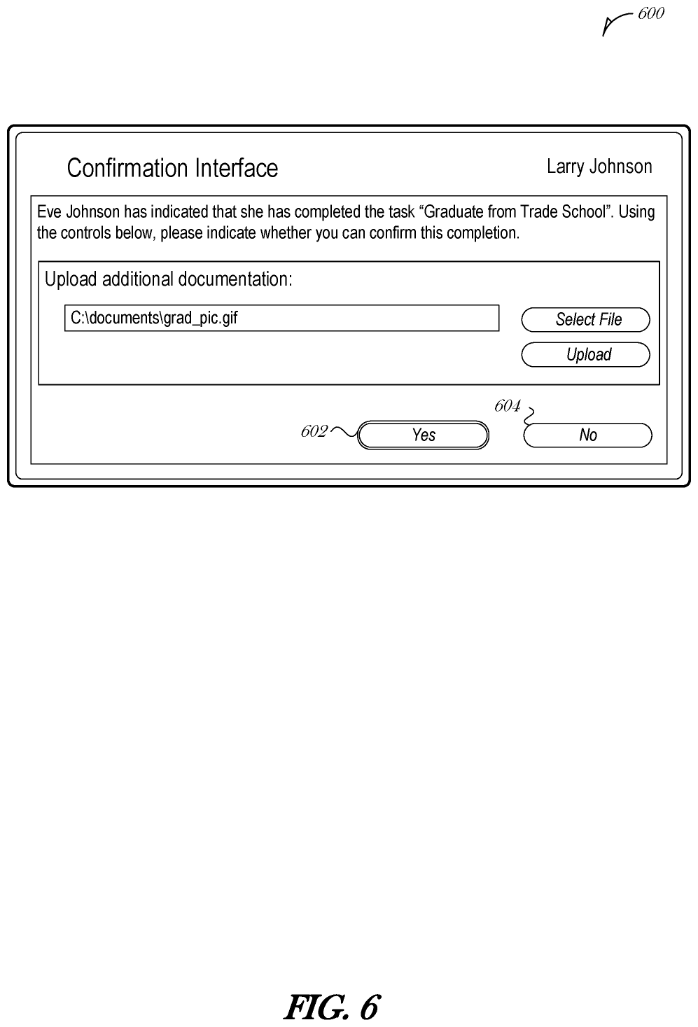

FIG. 6 is a user interface 600 to confirm the completion of an task in a conditional bequest, according to an embodiment. The user interface 600 may be presented, for example, to one or more users after a beneficiary user indicates the completion of a task. Information is displayed in the user interface 600 and the user may activate either the “yes” user control 602 or the “no” user control 604 to answer the question of whether the user believes or knows that the beneficiary completed the task. Optionally, an upload control 606 may be displayed to allow the user to upload text, documents, or the like to support their response.

An electronic message may be transmitted to the digital estate planning system with an indication that the user has responded to the confirmation query. The message may include a user identifier, a task identifier, a date and time stamp, a result of the confirmation (e.g., success or failure), and other information to track the status of the task. The message may be sent using a RESTful interface, HTML, or another messaging format.

One or more people may be asked to confirm the completion of a task. The people to confirm the completion may be selected by the testator. Respondents may have different weights for their response. For example, the testator may decide that he trusts his eldest sone more than his youngest son, so the eldest son is given a more value vote (e.g., double the weight of the youngest). The response from the people asked to confirm may be tabulated to determine a score, percentage of confirmation, or other indication of responses. A consensus threshold may be set by the testator, for example it may be that 100% agreement is required. Optionally, a lower threshold, such as 75% may be used.

If the responses are sufficient to indicate that the beneficiary completed their task, then the funds or gift may be automatically released or transferred to the beneficiary. Monetary funds, for example, may be transferred electronically from one financial institution to another.

In an example use case, a testator may draft a conditional bequest to a son in that if the son gets married, a gift is provided to the son. The son has two siblings and each has a voting share for this task. After the testator passes, the son gets married and uses the digital estate planning system to indicate that he has completed the condition. The siblings may not need to see a marriage certificate or validate that the event happened in another way because they attended the event in person. As a result, the siblings can log into their accounts on the digital estate planning system and provide their confirmations. The bequest is then automatically transferred up on the consensus confirmation.

If a sibling was not at the event, then they may still confirm upon information and belief. For example, the sibling may have seen pictures on a social media post, talked with friends or family who were in attendance, or met the couple later after the wedding. In some instances, the sibling may upload documentation to support her confirmation, such as a picture of the married couple, a picture of the marriage certificate, an audio recording of the beneficiary, or the like.

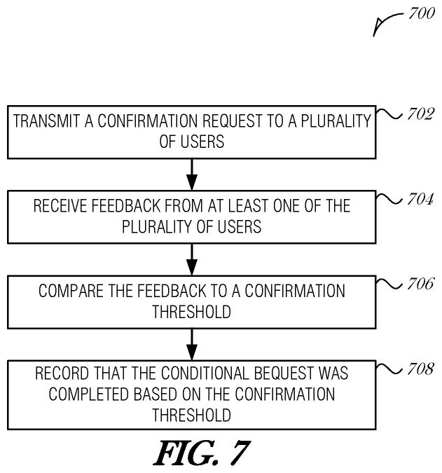

FIG. 7 is a flowchart illustrating a method 700 for confirming completion of a conditional bequest, according to an embodiment. The method 700 may be performed by an electronic system (e.g., online system 106) or any of the modules, logic, circuits, processors, or components described herein. The method 700 may be used to manage conditional bequests from a testator's estate.

At 702, the method 700 includes transmitting a confirmation request to a plurality of users of the online system, the confirmation request to provide feedback on a completion of a conditional bequest, the conditional bequest comprising a task to be completed by a beneficiary and a gift to be given to the beneficiary after completion of the task.

At 704, the method 700 includes receiving feedback from at least one of the plurality of users. In an embodiment, the feedback includes documentation to support the feedback. In various embodiments, the documentation is an image, an audio file, or a video.

At 706, the method 700 includes comparing the feedback to a confirmation threshold. In an embodiment, each of the plurality of users has a number of votes. In an embodiment, the confirmation threshold is a percentage of votes received from the plurality of users. In an embodiment, each of the plurality of users has a different number of votes.

In an embodiment, a vote of one of the plurality of users has a different weight than a vote of another of the plurality of users. For instance, an elder brother may be given a vote that counts for more than a younger brother when asked to confirm the existence of an event.

In an embodiment, the confirmation threshold is less than 100%. For instance, a confirmation threshold of 75%, 50%, or some other value may be used if the testator desires. In such cases, the lower threshold may provide a good enough estimation that the conditional bequest was completed.

At 708, the method 700 includes recording that the conditional bequest was completed when the feedback satisfies the confirmation threshold.

In an embodiment, the conditional bequest is included in a will, and the plurality of users is selected by a testator of the will. In another embodiment, the conditional bequest is included in a will, and the plurality of users is selected by an executor of the will.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

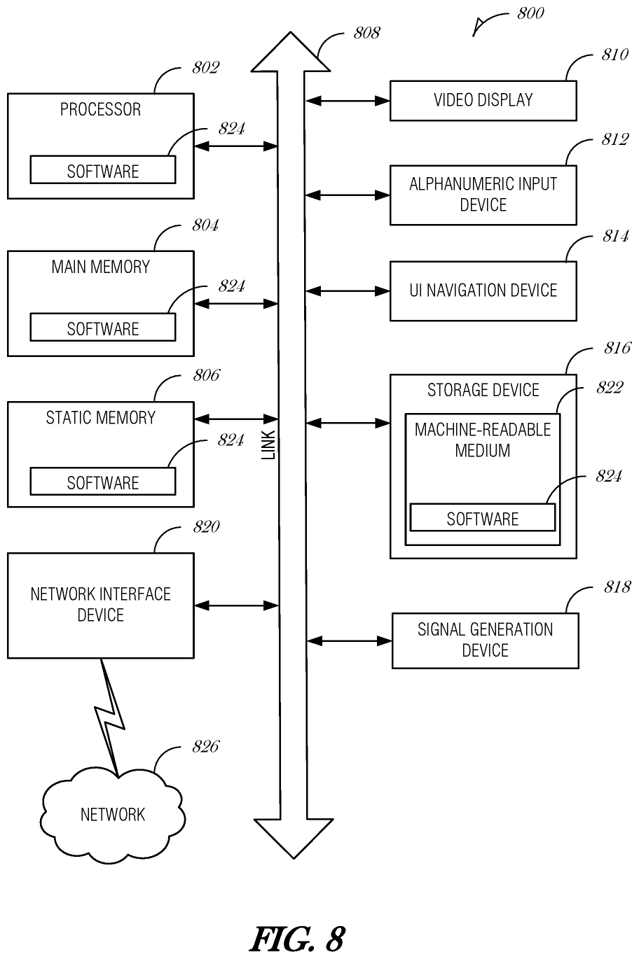

FIG. 8 is a block diagram illustrating a machine in the example form of a computer system 800, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, set-top box, wearable device, personal computer (PC), a tablet PC, a hybrid tablet, a personal digital assistant (PDA), a mobile telephone, cloud server, web server, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 800 includes at least one processor 802 (e.g., a central processing unit (CPU), a graphics processing unit (GPU) or both, processor cores, compute nodes, etc.), a main memory 804 and a static memory 806, which communicate with each other via a link 808 (e.g., bus). The computer system 800 may further include a video display unit 810, an alphanumeric input device 812 (e.g., a keyboard), and a user interface (UI) navigation device 814 (e.g., a mouse). In one embodiment, the video display unit 810, input device 812 and UI navigation device 814 are incorporated into a touch screen display. The computer system 800 may additionally include a storage device 816 (e.g., a drive unit), a signal generation device 818 (e.g., a speaker), a network interface device 820, and one or more sensors (not shown), such as a global positioning system (GPS) sensor, compass, accelerometer, or other sensor.

The storage device 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804, static memory 806, and/or within the processor 802 during execution thereof by the computer system 800, with the main memory 804, static memory 806, and the processor 802 also constituting machine-readable media.

While the machine-readable medium 822 is illustrated in an example embodiment to be a single medium, the term “machine-readable medium” may include a single medium or multiple media (e.g., a centralized or distributed database, and/or associated caches and servers) that store the one or more instructions 824. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### ADDITIONAL NOTES & EXAMPLES

Example 1 is an online system for managing conditional bequests from a testator's estate, the online system comprising: a processor subsystem; and memory including instructions, which when executed by the processor subsystem, cause the processor subsystem to: transmit a confirmation request to a plurality of users of the online system, the confirmation request to provide feedback on a completion of a conditional bequest, the conditional bequest comprising a task to be completed by a beneficiary and a gift to be given to the beneficiary after completion of the task; receive feedback from at least one of the plurality of users; compare the feedback to a confirmation threshold; and record that the conditional bequest was completed when the feedback satisfies the confirmation threshold.

In Example 2, the subject matter of Example 1 includes, wherein each of the plurality of users has a number of votes.

In Example 3, the subject matter of Examples 1-2 includes, wherein the confirmation threshold is a percentage of votes received from the plurality of users.

In Example 4, the subject matter of Examples 1-3 includes, wherein each of the plurality of users has a different number of votes.

In Example 5, the subject matter of Examples 1-4 includes, wherein a vote of one of the plurality of users has a different weight than a vote of another of the plurality of users.

In Example 6, the subject matter of Examples 1-5 includes, wherein the confirmation threshold is less than 100%.

In Example 7, the subject matter of Examples 1-6 includes, wherein the feedback includes documentation to support the feedback.

In Example 8, the subject matter of Example 7 includes, wherein the documentation is an image.

In Example 9, the subject matter of Examples 7-8 includes, wherein the documentation is an audio file.

In Example 10, the subject matter of Examples 7-9 includes, wherein the documentation is a video.

In Example 11, the subject matter of Examples 1-10 includes, wherein the conditional bequest is included in a will, and the plurality of users is selected by a testator of the will.

In Example 12, the subject matter of Examples 1-11 includes, wherein the conditional bequest is included in a will, and the plurality of users is selected by an executor of the will.

Example 13 is a method for managing conditional bequests from a testator's estate, the method performed on an electronic online system, the method comprising: transmitting a confirmation request to a plurality of users of the online system, the confirmation request to provide feedback on a completion of a conditional bequest, the conditional bequest comprising a task to be completed by a beneficiary and a gift to be given to the beneficiary after completion of the task; receiving feedback from at least one of the plurality of users; comparing the feedback to a confirmation threshold; and recording that the conditional bequest was completed when the feedback satisfies the confirmation threshold.

In Example 14, the subject matter of Example 13 includes, wherein each of the plurality of users has a number of votes.

In Example 15, the subject matter of Examples 13-14 includes, wherein the confirmation threshold is a percentage of votes received from the plurality of users.

In Example 16, the subject matter of Examples 13-15 includes, wherein each of the plurality of users has a different number of votes.

In Example 17, the subject matter of Examples 13-16 includes, wherein a vote of one of the plurality of users has a different weight than a vote of another of the plurality of users.

In Example 18, the subject matter of Examples 13-17 includes, wherein the confirmation threshold is less than 100%.

In Example 19, the subject matter of Examples 13-18 includes, wherein the feedback includes documentation to support the feedback.

In Example 20, the subject matter of Example 19 includes, wherein the documentation is an image.

In Example 21, the subject matter of Examples 19-20 includes, wherein the documentation is an audio file.

In Example 22, the subject matter of Examples 19-21 includes, wherein the documentation is a video.

In Example 23, the subject matter of Examples 13-22 includes, wherein the conditional bequest is included in a will, and the plurality of users is selected by a testator of the will.

In Example 24, the subject matter of Examples 13-23 includes, wherein the conditional bequest is included in a will, and the plurality of users is selected by an executor of the will.

Example 25 is a non-transitory machine-readable medium comprising instructions for managing conditional bequests from a testator's estate, which when executed by a machine, cause the machine to: transmit a confirmation request to a plurality of users of the online system, the confirmation request to provide feedback on a completion of a conditional bequest, the conditional bequest comprising a task to be completed by a beneficiary and a gift to be given to the beneficiary after completion of the task; receive a response from at least one of the plurality of users; compare the feedback to a confirmation threshold; and record that the conditional bequest was completed when the feedback satisfies the confirmation threshold.

In Example 26, the subject matter of Example 25 includes, wherein each of the plurality of users has a number of votes.

In Example 27, the subject matter of Examples 25-26 includes, wherein the confirmation threshold is a percentage of votes received from the plurality of users.

In Example 28, the subject matter of Examples 25-27 includes, wherein each of the plurality of users has a different number of votes.

In Example 29, the subject matter of Examples 25-28 includes, wherein a vote of one of the plurality of users has a different weight than a vote of another of the plurality of users.

In Example 30, the subject matter of Examples 25-29 includes, wherein the confirmation threshold is less than 100%.

In Example 31, the subject matter of Examples 25-30 includes, wherein the feedback includes documentation to support the feedback.

In Example 32, the subject matter of Example 31 includes, wherein the documentation is an image.

In Example 33, the subject matter of Examples 31-32 includes, wherein the documentation is an audio file.

In Example 34, the subject matter of Examples 31-33 includes, wherein the documentation is a video.

In Example 35, the subject matter of Examples 25-34 includes, wherein the conditional bequest is included in a will, and the plurality of users is selected by a testator of the will.

In Example 36, the subject matter of Examples 25-35 includes, wherein the conditional bequest is included in a will, and the plurality of users is selected by an executor of the will.

Example 37 is at least one machine-readable medium including instructions that, when executed by processing circuitry, cause the processing circuitry to perform operations to implement of any of Examples 1-36.

Example 38 is an apparatus comprising means to implement of any of Examples 1-36.

Example 39 is a system to implement of any of Examples 1-36.

Example 40 is a method to implement of any of Examples 1-36.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. An online system for managing conditional bequests from a testator's estate, the online system comprising:
a processor subsystem; and
memory including instructions, which when executed by the processor subsystem, cause the processor subsystem to:
transmit a confirmation request to a plurality of users of the online system, the confirmation request to provide feedback on a completion of a conditional bequest, the conditional bequest comprising a task to be completed by a beneficiary and a gift to be given to the beneficiary after completion of the task;
receive feedback from at least one of the plurality of users;
compare the feedback to a confirmation threshold; and
record that the conditional bequest was completed when the feedback satisfies the confirmation threshold.

2. The online system of claim 1, wherein each of the plurality of users has a number of votes.

3. The online system of claim 1, wherein the confirmation threshold is a percentage of votes received from the plurality of users.

4. The online system of claim 1, wherein each of the plurality of users has a different number of votes.

5. The online system of claim 1, wherein a vote of one of the plurality of users has a different weight than a vote of another of the plurality of users.

6. The online system of claim 1, wherein the confirmation threshold is less than 100%.

7. The online system of claim 1, wherein the feedback includes documentation to support the feedback.

8. The online system of claim 7, wherein the documentation is an image.

9. The online system of claim 7, wherein the documentation is an audio file.

10. The online system of claim 7, wherein the documentation is a video.

11. The online system of claim 1, wherein the conditional bequest is included in a will, and the plurality of users is selected by a testator of the will.

12. The online system of claim 1, wherein the conditional bequest is included in a will, and the plurality of users is selected by an executor of the will.

13. A method for managing conditional bequests from a testator's estate, the method performed on an electronic online system, the method comprising:
transmitting a confirmation request to a plurality of users of the online system, the confirmation request to provide feedback on a completion of a conditional bequest, the conditional bequest comprising a task to be completed by a beneficiary and a gift to be given to the beneficiary after completion of the task;
receiving feedback from at least one of the plurality of users;
comparing the feedback to a confirmation threshold; and
recording that the conditional bequest was completed when the feedback satisfies the confirmation threshold.

14. The method of claim 13, wherein each of the plurality of users has a number of votes.

15. The method of claim 13, wherein the confirmation threshold is a percentage of votes received from the plurality of users.

16. The method of claim 13, wherein each of the plurality of users has a different number of votes.

17. The method of claim 13, wherein a vote of one of the plurality of users has a different weight than a vote of another of the plurality of users.

18. The method of claim 13, wherein the confirmation threshold is less than 100%.

19. The method of claim 13, wherein the feedback includes documentation to support the feedback.

20. A non-transitory machine-readable medium comprising instructions for managing conditional bequests from a testator's estate, which when executed by a machine, cause the machine to:
transmit a confirmation request to a plurality of users of the online system, the confirmation request to provide feedback on a completion of a conditional bequest, the conditional bequest comprising a task to be completed by a beneficiary and a gift to be given to the beneficiary after completion of the task;
receive a response from at least one of the plurality of users;
compare the feedback to a confirmation threshold; and
record that the conditional bequest was completed when the feedback satisfies the confirmation threshold.
